(19) United States
(12) Patent Application Publication
(10) Pub. No.: US 2023/0356213 A1
(43) Pub. Date: Nov. 9, 2023

(54) ANALYTE INSPECTION APPARATUS AND ANALYTE INSPECTION METHOD USING SAME

(71) Applicant: ALIGNED GENETICS, INC., Anyang-si (KR)

(72) Inventors: Ghun KOH, Anyang-si (KR); Neoncheol JUNG, Anyang-si (KR)

(21) Appl. No.: 18/351,020

(22) Filed: Jul. 12, 2023

Related U.S. Application Data
(63) Continuation of application No. PCT/KR2021/020233, filed on Dec. 30, 2021.

(30) Foreign Application Priority Data
Jan. 14, 2021 (KR) 10-2021-0005516

(51) Int. Cl. B01L 3/00

(52) U.S. Cl. CPC B01L 3/502; B01L 2300/087; B01L 2400/043; B01L 2300/0809

(57) ABSTRACT

An analyte inspection apparatus is proposed. The apparatus may a body portion having one side open and a main space in which a sample is accommodated. The apparatus may also include a piston including one or more partition walls partitioning the main space, the piston being inserted into the main space of the body portion to be movable back and forth. The apparatus may further include an exchange flow path for providing a passage for the sample to flow. The exchange flow path may communicate with any one of the plurality of compartments separated by the one or more partition walls depending on a position of the piston.

### CROSS REFERENCE TO RELATED APPLICATIONS

This is a continuation application of International Patent Application No. PCT/KR2021/020233, filed on Dec. 30, 2021, which claims priority to Korean patent application No. 10-2021-0005516 filed on Jan. 14, 2021, contents of both of which are incorporated herein by reference in their entireties.

### BACKGROUND

### Technical Field

The present disclosure relates to an analyte inspection apparatus and an analyte inspection method.

### Description of Related Technology

In general, samples collected from human or animal bodies are purified in laboratories to perform predetermined tests. In this case, pretreatment, purification, etc. are generally carried out on the samples by chemical and physical methods using a predetermined apparatus, and the samples purified in this way are finally collected in the form of an analyte to perform a predetermined test. Examples of such an analyte inspection apparatus and method and an analyte inspection system for detecting various biological components such as cells, proteins, and nucleic acids include a nucleic acid purification apparatus and method and a purified nucleic acid inspection system.

### SUMMARY

One aspect is an analyte inspection apparatus through which it is possible to purify an analyte of a sample and inspect the purified analyte using the same apparatus.

Another aspect is an analyte inspection apparatus that has a small size and requires low cost, through which it is possible to perform sample tests economically.

In accordance with one aspect of the present disclosure, there is provided an analyte inspection apparatus including: a body portion having one side open and a main space in which a sample is accommodated; a piston including one or more partition walls partitioning the main space and the piston being inserted into the main space of the body portion to be movable back and forth; and an exchange flow path for providing a passage for the sample to flow, wherein the exchange flow path communicates with any one of the plurality of compartments separated by the one or more partition walls depending on a position of the piston.

At least one of the plurality of compartments may be provided to be filled with a solution for purifying an analyte in the sample.

The exchange flow path may be formed to have one side communicating with the main space, and the sample accommodated in the main space may flow from the main space to the exchange flow path by a pressure difference applied to a discharge part, the discharge part being configured to communicate with an outside.

The body portion may include an exchange hole through which the analyte flows into the exchange flow path and an opening through which the main space is exposed to an outside, and the exchange hole and the opening may be formed at positions to communicate with each other through the main space partitioned by the partition wall.

The body portion may include a protruding part protruding from an end opposite to an end into which the piston is inserted, and an insertion space may be formed in the protruding part to insert at least a portion of the piston.

The body portion may include a blowback part which is provided at a position spaced apart from the protruding part by a predetermined distance and through which the main space communicates with an outside of the body portion.

The blowback part may include: a blowback inlet serving as a passage through which fluid in the main space is discharged; a blowback outlet serving as a passage through which fluid flows into the main space; and a bridge which extends in a direction in which the piston moves and through which the blowback inlet and the blowback outlet communicate with each other.

The body portion may include an outlet through which the analyte is discharged from the body portion after reacting with the solution in the main space and having undergone a predetermined treatment process, and the outlet may be formed at a position spaced apart from the protruding part by a predetermined distance and opposite to the blowback part.

The piston may move into the insertion space to block between the insertion space and the main space and the gas in the main space is blown back to push the analyte accommodated in the main space to the outlet.

The piston may further include a central pillar and a piston head protruding from one end of the central pillar, and the piston head may be selectively inserted into the insertion space according to a movement of the central pillar.

The one or more partition walls may include a plurality of partition walls, and the plurality of partition walls may extend radially from a circumferential surface of the central pillar and are spaced apart from each other in a direction in which the central pillar moves.

The piston may further include: a head sealing member for blocking between the insertion space and the main space by sealing a space between an inner circumferential surface of the protruding part and the piston head when the piston head is inserted into the insertion space; and a partition wall sealing member provided on an outer circumferential surface of the partition wall to prevent leakage of the solution between the partition wall and the body portion.

The body portion may include a blowback part which is provided at a position spaced apart from the protruding part by a predetermined distance and through which the main space communicates with an outside of the body portion, the piston head may have a head groove recessed from an outer circumferential surface of the piston head, the head sealing member may be interposed in the head groove, and the head groove may be formed at a position spaced apart from one end of the piston head by a predetermined distance so that the insertion space, the main space, and the blowback part may communicate with each other even when at least a portion of the piston head is inserted into the insertion space.

One of the one or more partition walls may be disposed between the compartments adjacent to each other among the plurality of compartments, in each of the plurality of compartments, a predetermined solution may be filled or the sample may be injected, and each of the plurality of compartments may perform a predetermined function based on the predetermined solution or the sample.

In accordance with another aspect of the present disclosure, there is provided an analyte inspection method using an analyte inspection apparatus including a body portion in which a main space is formed, including: a sample injection step of injecting a sample or a solution containing the sample into the main space; an analyte purification step of purifying an analyte included in the sample injected into the main space; and an analyte discharge step of discharging the purified analyte from the main space to be supplied to an inspection chamber, wherein the analyte inspection apparatus includes: a piston including one or more partition walls partitioning the main space; and an exchange flow path providing a passage through which the sample flows, wherein the exchange flow path communicates with any one of the plurality of compartments, which is separated by the one or more partition walls, depending on a position of the piston.

The analyte purification step may include: an analyte dissolution step in which the sample injected into the main space is dissolved with a dissolution solution to extract an analyte and the analyte is bound to at least one of a magnetic material and an internal control material; an analyte cleaning step in which the analyte is cleaned with a cleaning solution; and an analyte elution step in which the cleaned analyte is eluted from the magnetic material with an elution solution.

The body portion may have a blowback part through which the main space communicates with an outside of the body portion, and in the analyte discharge step, gas in the main space may be blown back through the blowback part so that the analyte purified in the analyte purification step may be discharged.

The sample or the solution containing the sample may include: at least one of a sample of a living body or an environmentally derived sample and a solution containing the living body sample or the environmentally derived sample when the main space is filled with a solution for purifying an analyte in the sample, and the sample or the solution containing the sample may include at least one of the living body sample or the environmentally derived sample and the solution containing the living body sample or the environmentally derived sample and the solution for purifying the analyte in the sample when the main space is not filled with the solution for purifying the analyte in the sample.

The cleaning solution may include at least one of a washing buffer, alcohol, and distilled water, and the elution solution may include at least one of an elution buffer, a chelating agent, and distilled water.

The analyte dissolution step may include a first separation step of separating an analyte from the solution by fixing the analyte to the exchange flow path using magnetic force while one of the plurality of compartments communicates with the exchange flow path, the analyte cleaning step may include a second separation step of separating the analyte from the cleaning solution by fixing the analyte to the exchange flow path while another one of the plurality of compartments communicates with the exchange flow path, and the analyte elution step may include a third separation step of separating the analyte using the elution solution filled in still another one of the plurality of compartments before discharging the analyte.

According to the embodiments of the present disclosure, it is possible to purify an analyte of a sample and inspect the purified analyte using the same apparatus.

Furthermore, since the apparatus has a small size and requires low cost, it is possible to perform sample tests economically.

### BRIEF DESCRIPTION OF THE DRAWINGS

FIG. 1 is a perspective view of an analyte inspection apparatus according to an embodiment of the present disclosure.

FIG. 2 is an exploded perspective view of FIG. 1.

FIG. 3 is a cross-sectional view taken along the line “III-III” in FIG. 1.

FIG. 4 is an enlarged view of the part “B” in FIG. 3.

FIGS. 5A and 5B are views illustrating a process in which blowback is generated in the analyte inspection apparatus in FIG. 1.

FIG. 6 is an enlarged view of the part “C” in FIG. 5A.

FIG. 7 is an enlarged view of the part “D” in FIG. 5A.

FIG. 8 is a bottom perspective view of a flow chamber adjusting portion in FIG. 1.

FIG. 9 is a flowchart schematically illustrating a method of inspecting an analyte using the analyte inspection apparatus according to an embodiment of the present disclosure.

### DETAILED DESCRIPTION

The technology to purify and detect nucleic acids is an essential technology that is widely used in genetic engineering and molecular biology, and has been widely used for biotechnology research and medical and industrial purposes. In particular, the technology has been used in a wide variety of fields such as detection of microbial infections, detection of biomarkers, detection of gene sequences, and detection of mutant genes, and are essential elements for diagnosis based on genes. Purification of nucleic acids has conventionally been performed by dissolving biomaterials by chemical and physical methods using ultrasound, heat, proteinase, alcohols, special reagents, etc. and then selectively binding nucleic acids to positively charged ion exchange resins or magnetic particles. In this process, researchers need to exchange solutions in each step of lysis, binding, washing, and elution, and purification of nucleic acids needs to be carried out manually or by an automated robot depending on the number of samples. In addition, the purified nucleic acids are generally transferred to a tube or well plate, which is a separate container for detection, and then mixed with an enzyme reaction solution for a nucleic acid amplification reaction in the container. The purification and detection of nucleic acids are completed only after the detection container is carried to an apparatus for reaction such as nucleic acid amplification and detection of nucleic acids. This process necessarily involves a number of steps including complicated pipetting and sequential mixing, stirring, and transfer of different reaction solutions. In the case of purification and detection of nucleic acids for diagnostic purposes, these methods generally require a lot of time and labor to be performed in a laboratory. In particular, when the number of samples is large, the process is performed using an automated robot, which requires a lot of space and cost. In addition, since the apparatus is operated when a certain number of samples are prepared, there is a disadvantage in that the inspection of a small number of samples is delayed. Particularly, such a test system cannot be applied to a medical field requiring rapid diagnosis results.

In particular, this laboratory-based diagnosis method has limitations in controlling the spread and testing of a wide range of infectious diseases such as pandemics, including the coronavirus pandemic. Therefore, the need for point-of-care testing (POCT), in which non-professional personnel immediately perform a test and obtain the results on-site, and the equipment for this is growing.

An analyte inspection apparatus for purifying a sample and quantitatively collecting it as an analyte can be available for the POCT when the number of personnel to carry out a purification process using the apparatus is minimized, the apparatus is filled with a predetermined solution for the purification, and the size of the apparatus is small enough to be portable. In addition, since one-time property of the apparatus needs to be secured to prevent contamination by biological materials, the apparatus should be provided as a low-cost apparatus. However, until now, research on an analyte inspection apparatus that perfectly satisfies these conditions and an analyte inspection method using the same has not been actively conducted.

Hereinafter, embodiments of the present disclosure for implementing the spirit of the present disclosure will be described in more detail with reference to the accompanying drawings.

However, in describing the present disclosure, detailed descriptions of known configurations or functions may be omitted to clarify the present disclosure.

When an element is referred to as being ‘connected’ to, ‘supported’ by, ‘flowed’ in ‘supplied’ to, ‘flowed’, or ‘coupled’ to another element, it should be understood that the element may be directly connected to, supported by, flowed in, supplied to, flowed, or coupled to another element, but that other elements may exist in the middle.

The terms used in the present disclosure are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements and/or combinations thereof disclosed in the specification, and are not intended to preclude the possibility that one or more other certain features, areas, integers, steps, actions, elements and/or combinations thereof may exist or may be added.

In addition, it is noted in advance that expressions such as upper portion, side surface, bottom surface, etc. are described based on the illustration of drawings, but may be modified if directions of corresponding objects are changed.

Hereinafter, specific features of an analyte inspection apparatus 1 according to an embodiment of the present disclosure will be described with reference to the accompanying drawings.

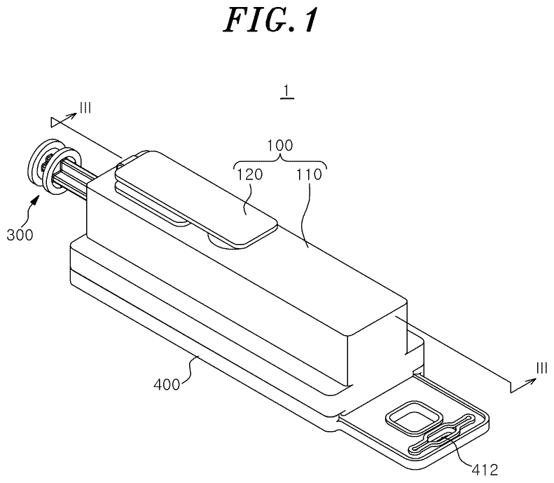

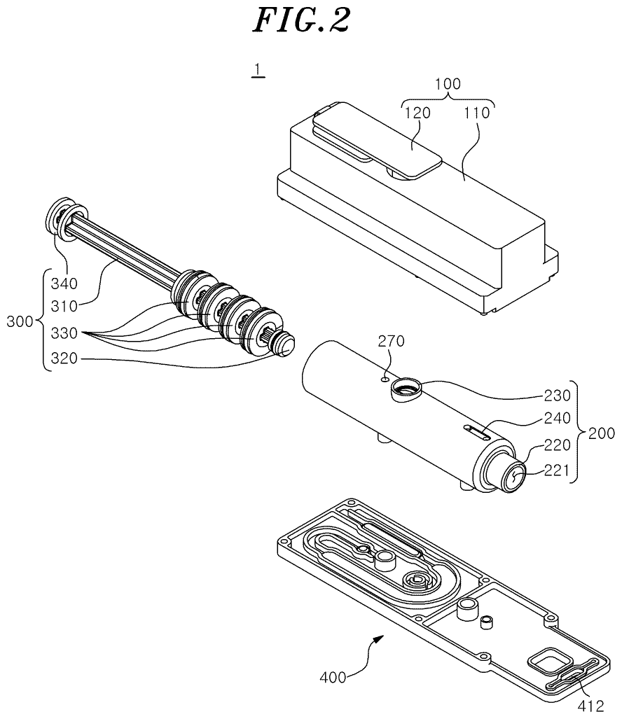

Hereinafter, referring to FIGS. 1 and 2, the analyte inspection apparatus 1 according to an embodiment of the present disclosure may be used to purify samples taken from living bodies or the environment and perform a predetermined test thereon. For example, the samples taken from living bodies or the environment may be a human, animal, or plant sample. The analyte inspection apparatus 1 may include a case 100, a body portion 200, a piston 300, and a flow chamber adjusting portion 400. For example, the case 100, the body portion 200, the piston 300, and the flow chamber adjusting portion 400 of the analyte inspection apparatus 1 may be made of any one of plastic, rubber, ceramic, inorganic compound, or metal, or a combination thereof.

In addition, the case 100, the body portion 200, the piston 300, and the flow chamber adjusting portion 400 may be formed by a process such as blow molding, compression molding, extrusion molding, injection molding, laminating, reaction injection molding, matrix molding, rotational molding, spin casting, transfer molding, thermoforming, and 3D printing. It may be possible that the case 100, the body portion 200, the piston 300, and the flow chamber adjusting portion 400 are mass-produced by a pre-equipped automated facility and are produced for one-time use, for example. In addition, they may be individually manufactured and assembled so as to form one analyte inspection apparatus 1.

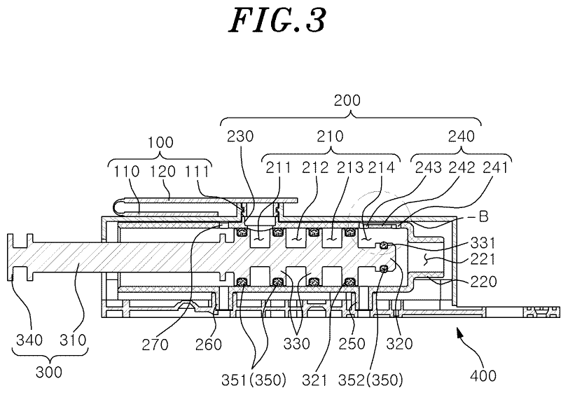

Referring to FIGS. 2 and 3, the case 100 may accommodate at least a portion of the body portion 200, the piston 300, and the flow chamber adjusting portion 400. The case 100 may be supported by the flow chamber adjusting portion 400. Furthermore, the case 100 may include a case cover part 110 and a lid part 120.

The case cover part 110 may accommodate at least a portion of the body portion 200, the piston 300, and the flow chamber adjusting portion 400 and may be supported by the flow chamber adjusting portion 400. An engaging hole 111 that engages with the lid part 120 may be formed on one surface of the case cover part 110.

The lid part 120 may be engaged with the engaging hole 111 of the case cover part 110, and an inlet 230 of the body portion 200, which will be described later, may be opened and closed by the lid part 120. In other words, the inlet 230 may be opened when the lid part 120 is separated from the engaging hole 111, and the inlet 230 may be closed when the lid part 120 is engaged with the engaging hole 111. When the analyte inspection apparatus 1 is not in use, the lid part 120 may seal the inlet 230 to prevent external foreign substances from entering a main space 210 of the body portion 200, which will be described later. In addition, after a sample is injected into the main space 210 through the inlet 230, the lid part 120 may be engaged with the engaging hole 111 again to seal the inlet 230. Accordingly, it may be possible to prevent external foreign substances from entering the main space 210 by using the lid part 120 during a treatment process for an analyte as well as before the process.

The main space 210 may be formed inside the body portion 200 so that a sample or a solution containing the same can be injected thereinto. In addition, one end of the body portion 200 may be opened so that the piston 300 can be inserted thereinto, and one side of the main space 210 may be opened toward the outside. For example, the body portion 200 may have a cylindrical shape having a hollow therein. Furthermore, the main space 210 may have a shape corresponding to the piston 300 so that the piston 300 inserted into the main space 210 can move back and forth.

Meanwhile, a sample injected into the main space 210 may be, for example, a liquid phase, a solid phase, or a mixture thereof, which includes some or all of cells, viruses, tissues, exosomes, proteins, nucleic acids, antigens, and antibodies. More specifically, a sample injected into the main space 210 may be taken from a living body or the environment, and, in this case, intracellular nucleic acids present in the sample may be purified by using the analyte inspection apparatus 1.

In addition, the main space 210 of the body portion 200 may include a plurality of compartments 211, 212, 213, and 214. At least one of the plurality of compartments 211, 212, 213, and 214 may be filled with a solution for purifying a sample to extract an analyte therefrom. For example, the solution may be a solution containing a magnetic material.

Meanwhile, the plurality of compartments 211, 212, 213, and 214 may be partitioned by one or more partition walls 330 of the piston 300, which will be described later, and may include, for example, a first compartment 211, a second compartment 212, a third compartment 213, and a fourth compartment 214. The first compartment 211, the second compartment 212, the third compartment 213, and the fourth compartment 214 may be filled with different solutions. However, in this specification, the main space 210 is described as being divided into the four compartments, but this is only an example, which means that the main space 210 may also be partitioned into two, three, or five or more compartments and that the spirit of the present disclosure is not limited thereto. In other words, in each of the plurality of compartments in the main space 210, a predetermined solution is filled or a predetermined sample is injected, and a predetermined function is performed in each of the plurality of compartments based on the predetermined solution or the sample.

The first compartment 211 may be closest to an open end of the body portion 200 among the plurality of compartments 211, 212, 213, and 214. In order to inspect a sample, a dissolution solution and the sample or a solution containing the sample may be injected into the first compartment 211 through the inlet 230. For example, the dissolution solution refers to a solution that binds at least a portion of an analyte and a magnetic material, and the analyte refers to a material present in a biological material when the biological material contained in a sample is dissolved. In more detail, the dissolution solution injected into the first compartment 211 may include a lysis/binding buffer and, more specifically, may include some or all of magnetic nano/micro particles, salts (e.g., Tris-HCl), chelating agents (e.g., Ethylenediaminetetraacetic acid (EDTA)), surfactants/detergents (e.g., Sodium dodecyl sulfate (SDS) and Triton X-100), reductants (e.g., Dithiothreitol (DTT)), chaotropic agents (e.g., Guanidine thiocyanate), enzymes (e.g., Proteinase K), and distilled water.

However, this is only an example. The first compartment 211 may be pre-filled with a dissolution solution, and only a sample or a solution containing it may be injected through the inlet 230.

In addition, analytes collected by the analyte inspection apparatus 1 may be nucleic acids, proteins, exosomes, lipids, carbohydrates, cells (blood cells, immune cells, tumor cells, pathogenic microorganisms, etc.), etc. and may include a biological material itself contained in a sample or a material that can be separated therefrom by one or both of physical and chemical methods. Moreover, when intracellular nucleic acid present in a sample is purified using the analyte inspection apparatus 1, analytes collected by the analyte inspection apparatus 1 may include purified nucleic acids.

The second compartment 212 may be formed contiguous to the first compartment 211 with one of the one or more partition walls 330 interposed therebetween. The second compartment 212 may be a space between the first compartment 211 and the third compartment 213. In addition, the second compartment 212 may be filled with a cleaning solution for cleaning at least a portion of an analyte bound to a magnetic material. For example, the cleaning solution in the second compartment 212 may include a washing buffer and, more specifically, may include some or all of diethyl pyrocarbonate (DEPC), sodium citrate tribasic dehydrate, alcohol (e.g., ethanol and 2-propanol), and distilled water. The second compartment 212 may be filled with the cleaning solution in advance of injecting a sample and a solution into the first compartment 211.

The third compartment 213 may be formed contiguous to the second compartment 212 with one of the one or more partition walls 330 interposed therebetween. The third compartment 213 may be a space between the second compartment 212 and the fourth compartment 214. In addition, the third compartment 213 may be filled with an elution solution for eluting at least a portion of an analyte bound to a magnetic material from the magnetic material. For example, the elution solution in the third compartment 213 may include an elution buffer and, more specifically, may include some or all of salts (e.g., Tris-HCl), chelating agents (e.g., ethylenediaminetetraacetic acid (EDTA)), diethyl pyrocarbonate (DEPC), and distilled water. The third compartment 213 may be filled with the elution solution in advance of injecting a sample and a solution into the first compartment 211.

The fourth compartment 214 may be formed contiguous to the third compartment 213 with one of the one or more partition walls 330 interposed therebetween. The fourth compartment 214 may be provided at a position farthest from one open end of the body portion 200 among the plurality of compartments 211, 212, 213, and 214.

Meanwhile, the body portion 200 may include a protruding part 220. The protruding part 220 may protrude from an end of the body portion 200 on the opposite side of the side into which the piston 300 is inserted. For example, the body portion 200 and the protruding part 220 may have a hollow shape. Furthermore, the inner width of the protruding part 220 may be formed smaller than the inner width of the body portion 200. In addition, the inner width of the protruding part 220 may be greater than the thickness of a piston head 320 to be described later. Accordingly, when the piston head 320 is inserted into the protruding part 220, it may be spaced apart from the inner circumferential surface of the protruding part 220 by a predetermined distance.

An insertion space 221 into which the piston head 320 can be inserted may be formed in the protruding part 220. The insertion space 221 may communicate with the main space 210 of the body portion 200. In other words, the insertion space 221 may communicate with the fourth compartment 214 of the body portion 200. The insertion space 221 may be blocked from the main space 210 by the piston head 320 and a head sealing member 352 to be described later. The feature that the head sealing member 352 blocks the insertion space 221 from the main space 210 will be described in detail later.

In the meantime, the inlet 230 through which the main space 210 and the outside of the body portion 200 communicate with each other may be formed at the body portion 200. A solution containing a sample and a magnetic material may be injected from the outside into the main space 210 through the inlet 230. In addition, the inlet 230 may sequentially communicate with the plurality of compartments 211, 212, 213, and 214 as the piston 300 may move in one direction inside the main space 210. For example, when the piston 300 moves a predetermined distance with respect to the body portion 200 so that the first compartment 211 is disposed at a position where it communicates with the inlet 230, a solution and a sample or a solution containing the sample may be injected from the outside into the first compartment 211 through the inlet 230.

The inlet 230 may be selectively opened and closed by the lid part 120. In other words, the inlet 230 may be opened to the outside when the lid part 120 is separated from the engaging hole 111 of the case cover part 110, and may be closed to the outside when the lid part 120 is engaged with the engaging hole 111. In addition, a portion of the inlet 230 may have a shape having a wide upper surface and narrowing downward, and may have, for example, a funnel shape. However, the spirit of the present disclosure is not limited to the shape of the inlet 230.

In addition, when the inlet 230 communicates with at least one of the plurality of compartments 211, 212, 213, and 214, it may be disposed at a position where it communicates with an exchange hole 260 through the compartment. For example, the inlet 230 may be formed to face the exchange hole 260 to be described later. For another example, the inlet 230 and the exchange hole 260 may be formed on the same line. For still another example, when the piston 300 is inserted into the main space 210 as deeply as possible to the extent that the partition wall 330 closest to the piston head 320 does not block the opening of a blowback outlet 243 and an outlet 250, the inlet 230 may be disposed at a position where the inlet 230 and the exchange hole 260 communicate with the first compartment 211 at the same time. However, this is only an example, and the exchange hole 260 may also be formed at a position where it cannot simultaneously communicate with the inlet 230 and any one of the plurality of compartments 211, 212, 213, and 214.

Meanwhile, a blowback part 240 may be formed at the body portion 200. The blowback part 240 may be formed at an end opposite to a side of the body portion 200 into which the piston 300 is inserted, and both ends of the blowback part 240 may communicate with the main space 210. The blowback part 240 may be formed on one surface of the body portion 200. In other words, the blowback part 240 may be formed on the upper surface of the body portion 200, but the spirit of the present disclosure is not limited thereto. The blowback part 240 may also be formed on the side or bottom of the body portion 200. When the piston 300 moves forward toward the protruding part 220, gas such as air existing in the fourth compartment 214 may be blown back by the blowback part 240. In this way, the gas present in the fourth compartment 214 is blown back and flows into the third compartment 213, so that a purified analyte present in the third compartment 213 may flow into a supply passage 413 to be described later through the outlet 250 to be described later. Further, the blowback part 240 may communicate the first compartment 211 and the second compartment 212 or the second compartment 212 and the third compartment 213, if necessary. That is, the blowback part 240 may allow two neighboring compartments to communicate with each other.

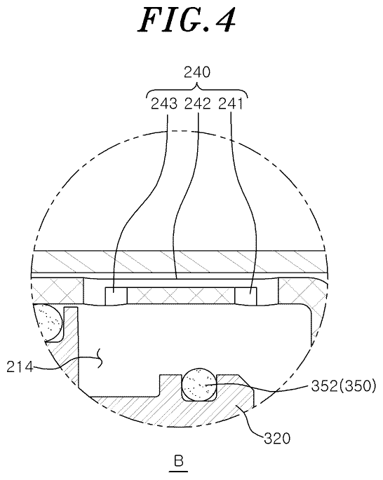

Referring to FIG. 4, the blowback part 240 may include a blowback inlet 241, a bridge 242, and the blowback outlet 243. One end of each of the blowback inlet 241 and the blowback outlet 243 may communicate with the main space 210, and the other ends of the blowback inlet 241 and the blowback outlet 243 may communicate with each other through the bridge 242. Moreover, the bridge 242 may be formed to have an open top surface. However, the open portion of the bridge 242 may be blocked from the outside by the case 100. As such, the blowback part 240 may be formed as a “U”-shaped channel by the blowback inlet 241, the bridge 242, and the blowback outlet 243. Meanwhile, a film may be used to form the channel formed by the blowback part 240. For example, by blocking the open portion of the bridge 242 using a film, the blowback part 240, which may have the “U” shape, may be blocked from the outside.

The blowback inlet 241 may be formed closer to the protruding part 220 of the main space 210 than the blowback outlet 243. Accordingly, when the piston 300 is moved in a direction of narrowing the fourth compartment 214, gas such as air in the fourth compartment 214 may be introduced into the blowback inlet 241 by pressure, pass through the bridge 242 and the blowback outlet 243, and then flow into the third compartment 213 contiguous to the fourth compartment 214. An analyte accommodated in the third compartment 213 by the pressure of the gas introduced into the third compartment 213 may be pushed out through the outlet 250 and flow into the supply passage 413. The analyte pushed out through the outlet 250 may be accommodated in an inspection chamber 412 to be described later through the supply passage 413.

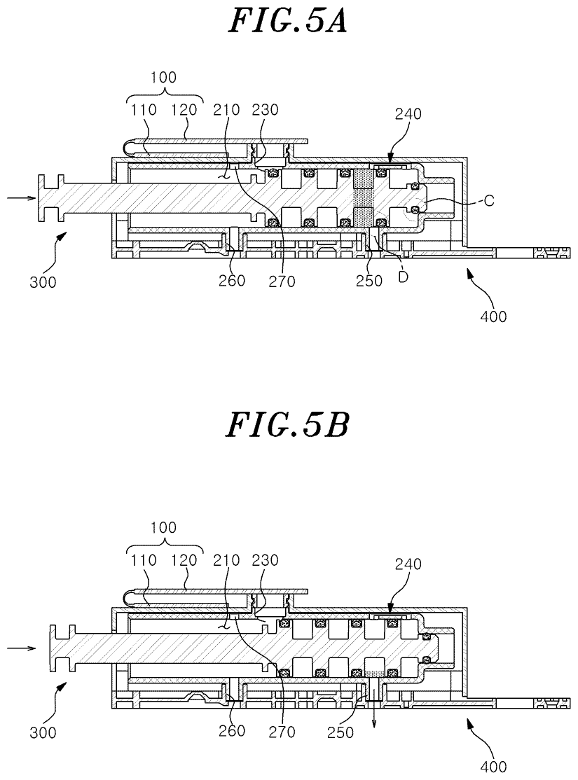

Hereinafter, with reference to FIGS. 5A to 7, a process in which gas such as air in the fourth compartment 214 is blown back will be described in more detail. First, when the piston 300 moves in one direction (e.g., the rightward direction in FIG. 5A) toward the protruding part 220, the gas in the fourth compartment 214 may flow into the blowback part 240 and the insertion space 221. In this case, the blowback outlet 243 of the blowback part 240 may communicate with the third compartment 213, and the blowback inlet 241 may communicate with the fourth compartment 214 (see FIG. 5A).

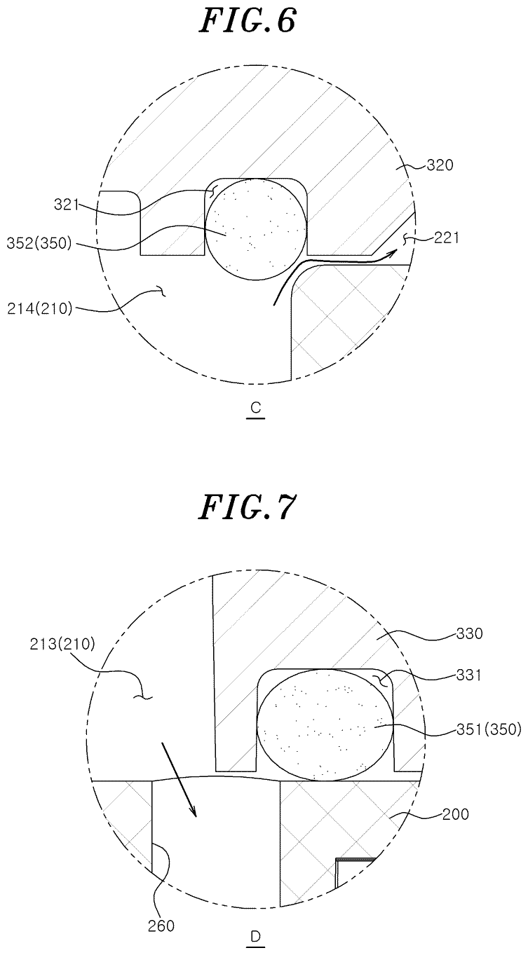

In addition, the gas in the fourth compartment 214 may continue to flow into the insertion space 221 through the space between the piston head 320 and the inner portion of the protruding part 220 as well as into the blowback part 240 (see FIG. 6). In this case, at least a part of the outlet 250 may communicate with the third compartment 213 (see FIG. 7). As such, since the gas in the fourth compartment 214 may be dispersed and flow into the insertion space 221 and the blowback part 240 even when the piston 300 is inserted into the insertion space 221, the pressure of the gas flowing into the blowback part 240 may be lower than the critical pressure for pushing out an analyte in the third compartment 213 to the outlet 250. Therefore, even when a part of the outlet 250 and the third compartment 213 communicate with each other as a result of the movement of the piston 300, gas in the main space 210 may not blow back, and a solution inside the main space 210 may not flow into the outlet 250 and the supply passage 413.

Thereafter, the piston 300 may be further moved toward the insertion space 221 of the protruding part 220 so that the head sealing member 352 may seal the space between the inner circumferential surface of the protruding part 220 and the piston head 320, thereby blocking the insertion space 221 and the fourth compartment 214. In this case, gas in the fourth compartment 214 may not flow into the insertion space 221, but may start to blow back by the blowback part 240 and flow into the third compartment 213. In addition, as the piston 300 is gradually inserted into the main space 210, an analyte and a solution in the third compartment 213 may be pushed out to the outlet 250. In other words, when the piston 300 moves further toward the insertion space 221 so that a portion of the outlet 250 equal to or larger than a predetermined area communicates with the third compartment 213, the gas in the main space 210 may begin to blow back, and the solution may flow into the supply passage 413 through the outlet 250 (see FIG. 5B).

As such, even when a part of the outlet 250 starts to communicate with the main space 210, the blowback may not start, and an analyte may not flow into the outlet 250, until the insertion space 221 and the fourth compartment 214 are completely blocked. In addition, when the insertion space 221 and the fourth compartment 214 are blocked and a portion of the outlet 250 equal to or larger than a predetermined area communicates with the main space 210, the analyte may flow into the outlet 250. In this case, the analyte and the solution flowing into the supply passage 413 may flow continuously, and the formation of liquid fragments may be prevented.

Here, a brief description of the process in which the liquid fragments are formed is as follows. For example, when only a very small area of the outlet 250 is opened and communicates with the main space 210, a very small amount of analyte and solution may flow into the supply passage 413. In this case, the liquid fragments may be formed as the solution flowing through the supply passage 413 flows discontinuously due to the factors such as viscosity of the solution and air remaining in the supply passage 413. When these liquid fragments are supplied to the inspection chamber 412, they may cause incomplete reactions or lower the accuracy of test results. However, when the blowback part 240 is used, it may be possible that liquid fragments are not formed on the inner surface of the supply passage 413 and that an analyte and a solution continuously flow through the supply passage 413 and are supplied to the inspection chamber 412.

Meanwhile, by means of the blowback part 240, it may be possible that a user finely adjusts the amount of gas to be blown back by the blowback part 240 by adjusting the level of pressurization of the piston 300. In this way, it may be possible to finely control the amount of analyte pushed out through the outlet 250 by adjusting the amount of blowback gas. As such, since, according to the present embodiment, it is possible to finely control the amount of analyte flowing into the supply passage 413 by finely adjusting the level of pressurization of the piston 300, the analyte inspection apparatus 1 according to the present embodiment may be useful, especially when performing a test in which the quantitative distribution of analytes is very important.

On the other hand, the body portion 200 may have the outlet 250 through which a sample that has reacted with a solution in the main space 210 and has undergone a predetermined treatment process can be pushed out from the main space 210 of the body portion 200 as an analyte. The outlet 250 may be located at an opposite end of the side of the body portion 200 into which the piston 300 is inserted, and may be formed at a position opposite to the blowback part 240. However, this is only an example, and the outlet 250 may also be formed at a position not facing the blowback part 240. In addition, the outlet 250 may be formed on the bottom of the main space 210 so that an analyte can be easily sent out under the influence of gravity. This is only an example, and the outlet 250 may also be formed on the side or top of the main space 210.

Furthermore, the outlet 250 may communicate with the supply passage 413 of the flow chamber adjusting portion 400, and an analyte sent out through the outlet 250 may flow into the inspection chamber 412 through the supply passage 413.

Meanwhile, the body portion 200 may further have the exchange hole 260 through which solutions and samples in the main space 210 can be introduced or discharged and an opening 270 exposing the main space 210 to the outside.

The exchange hole 260 may communicate with an exchange flow path 411. For example, a solution and a sample or a solution containing the sample in the main space 210 may flow into the exchange flow path 411 via the exchange hole 260. To be more specific, when a pressure difference occurs in a cylinder (not shown), air from the opening 270 may enter or exit the main space 210 in proportion to the amount of pressurization or decompression applied to the exchange flow path 411. As a result, a solution and a sample may flow from the main space 210 to the exchange flow path 411 through the exchange hole 260 and from the exchange flow path 411 to the main space 210.

In addition, the exchange hole 260 may be formed at a position facing the inlet 230 or the opening 270, or may be formed on the same line as the inlet 230 or the opening 270. Furthermore, the exchange hole 260 may be formed at a position within a range capable of simultaneously communicating with at least one of the inlet 230 and the opening 270 in the first compartment 211. As the piston 300 moves in one direction in the main space 210, the exchange hole 260 may communicate with the plurality of compartments 211, 212, 213, and 214 sequentially.

Meanwhile, in the present specification, a cylinder may be provided to apply a pressure difference necessary for the main space 210 to exchange solutions and samples with the exchange flow path 411. In addition, the cylinder may be designed to allow the pressure in the inner space to be changed, and, for example, the cylinder may be a syringe. Accordingly, a solution and a sample or a solution containing the sample may flow from one of the main space 210 and the exchange flow path 411 to the other of the main space 210 and the exchange flow path 411, depending on the pressure change in the cylinder. However, this is only an example, and the analyte inspection apparatus 1 may be connected to a syringe pump.

Referring back to FIGS. 2 and 3, the piston 300 may be formed to be inserted into the main space 210 through an opening of the body portion 200, and may be formed to move back and forth within the main space 210. In addition, the piston 300 may include a central pillar 310, the piston head 320, the partition wall 330, a piston holding part 340 and a sealing member 350.

The central pillar 310 may be inserted into the main space 210 of the body portion 200, and may connect the piston head 320, the partition wall 330, and the piston holding part 340. The central pillar 310 may be provided in a cylindrical shape, and the thickness thereof may vary depending on its position. Furthermore, in the center pillar 310, a portion connecting the piston holding part 340 and the partition wall 330 and a portion connecting a plurality of partition walls 330 may have different thicknesses. For example, the thickness of the portion connecting the plurality of partition walls 330 may be smaller than the thickness of the portion connecting the piston holding part 340 and the partition wall 330. This is to minimize the space occupied by the central pillar 310 in the plurality of compartments 211, 212, 213, and 214. However, this is only an example. The central pillar 310 may also have a uniform thickness, or the thickness of the portion connecting the plurality of partition walls 330 may be larger than the thickness of the portion connecting the piston holding part 340 and the partition wall 330.

The piston head 320 may protrude from the partition wall 330 connected to the end of the central pillar 310 among the plurality of partition walls 330. When the piston 300 is inserted into the body portion 200, the piston head 320 may be inserted into the insertion space 221 of the protruding part 220. In addition, the thickness of the piston head 320 may be larger than the thickness of the portion of the central pillar 310 between the plurality of partition walls 330 and may be smaller than the inner width of the protruding part 220. Therefore, when the piston head 320 is inserted into the insertion space 221, the outer circumferential surface of the piston head 320 may be spaced apart from the inner circumferential surface of the protruding part 220 by a predetermined distance, and, through the space spaced apart by the predetermined distance, gas in the fourth compartment 214 may flow into the insertion space 221. That is, it may be possible that the gas in the fourth compartment 214 is blown back by the piston head 320. In addition, the timing at which the blowback starts may be adjusted based on the length of the piston head 320 (the length of the portion protruding from the central pillar 310).

Moreover, the piston head 320 may have a head groove 321 into which the head sealing member 352 can be inserted. The head groove 321 may be recessed from the outer circumferential surface of the piston head 320. In addition, the head groove 321 may have a predetermined width so that the head sealing member 352 can be inserted therein.

One or more partition walls 330 may partition the main space 210. The plurality of partition walls 330 may be provided, and the plurality of partition walls 330 may radially extend from the circumferential surface of the central pillar 310. In addition, the plurality of partition walls 330 may be spaced apart from each other along the direction in which the central pillar 310 moves. The partition wall 330 may have a disk shape, and the diameter of the partition wall 330 may be smaller than or equal to the inner width of the body portion 200. In this specification, it has been described that four partition walls 330 are provided, but this is only an example, and any number of partition walls 330 other than four may be provided.

In addition, the partition wall 330 may have a partition wall groove 331 into which a partition wall sealing member 351 can be inserted. The partition wall groove 331 may be recessed from the outer circumferential surface of the partition wall 330. Furthermore, the partition wall groove 331 may have a predetermined width so that the partition wall sealing member 351 can be inserted.

The piston holding part 340 may be connected to the end of the central pillar 310 and may be a part where the piston 300 is gripped by a user. The piston holding part 340 may be provided in a disk shape, and may be provided in a flange shape with respect to the central pillar 310.

The sealing member 350 may seal a gap between the piston 300 and the inner surface of the body portion 200. For example, the sealing member 350 may be an O-ring made of a material such as rubber. The sealing member 350 may include the partition wall sealing member 351 and the head sealing member 352.

The partition wall sealing member 351 may prevent substances contained in the plurality of compartments 211, 212, 213, and 214 from leaking from the corresponding compartments. In other words, the partition wall sealing member 351 may prevent the different substances contained in the plurality of compartments 211, 212, 213, and 214 from being mixed with each other. The partition wall sealing member 351 may be disposed at the partition wall groove 331 to be in contact with the inner circumferential surface of the body portion 200. In addition, a gap between the partition wall 330 and the inner circumferential surface of the body portion 200 may be sealed by the partition wall sealing member 351. The partition wall sealing member 351 may be inserted into the partition wall groove 331 of the partition wall 330, so that the partition wall sealing member 351 does not separate from the partition wall 330 and can seal the gap between the partition wall 330 and the inner circumferential surface of the body portion 200.

The head sealing member 352 may block the insertion space 221 and the main space 210. In other words, the head sealing member 352 may block the insertion space 221 and the fourth compartment 214. The head sealing member 352 may be disposed at the head groove 321 to be in contact with the inner circumferential surface of the protruding part 220. In addition, a gap between the piston head 320 and the inner circumferential surface of the protruding part 220 may be sealed by the head sealing member 352. The head sealing member 352 may be inserted into the head groove 321 of the piston head 320, so that the head sealing member 352 does not separate from the piston head 320 and can seal the gap between the piston head 320 and the inner circumferential surface of the protruding part 220.

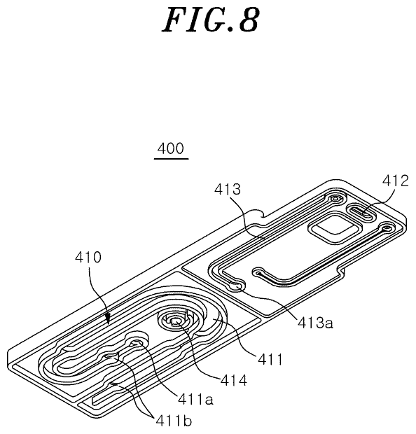

Referring to FIGS. 3 and 8, the flow chamber adjusting portion 400 may support the case 100, the body portion 200, and the piston 300. In addition, the flow chamber adjusting portion 400 may include a flow chamber 410, and the flow chamber 410 may serve as a flow path for analytes and solutions to flow and may serve as a space where the analytes react with enzymes for tests to be performed. The flow chamber adjusting portion 400 may be provided so that samples accommodated in the main space 210 are carried to induce a separation reaction of the analytes. For example, the analyte separation reaction occurring in the flow chamber adjusting portion 400 may be achieved by bringing the samples and magnetic materials into contact and applying a magnetic field to the flow chamber adjusting portion 400 to collect the magnetic materials.

The flow chamber adjusting portion 400 may be formed of a plurality of members. For example, the flow chamber adjusting portion 400 may include one or more base bodies formed by injection molding or the like and a base film attached to the bottom of the base body to form the flow chamber 410.

The flow chamber 410 may include the exchange flow path 411, the inspection chamber 412, the supply passage 413, and a discharge part 414.

The exchange flow path 411 may serve as a passage through which solutions and analytes flow between the main space 210 of the body portion 200 and a cylinder. A communication hole 411a for communicating with the exchange hole 260 may be provided on one side of the exchange flow path 411, and the exchange flow path 411 may communicate with the main space 210 through the communication hole 411a.

For example, solutions and analytes discharged from the main space 210 may flow into the flow chamber 410 through the communication hole 411a of the flow chamber 410 by a pressure difference applied by a cylinder. In addition, solutions separated from analytes by magnetic separation in the flow chamber 410 may flow back into the main space 210 through the exchange hole 260. In addition, the solutions and the analytes discharged from the main space 210 through the exchange hole 260 may flow to an external cylinder through the discharge part 414 of the flow chamber 410. As such, the flow chamber 410 may connect the main space 210 and the cylinder so that solutions and analytes in the main space 210 can freely flow into the flow chamber 410 and then flow into the main space 210 or the external cylinder.

In addition, the exchange flow path 411 may have an expansion passage 411b. An internal control material required for an inspection may be pre-injected into and fixed to the expansion passage 411b. For example, the expansion passage 411b may extend along at least a portion of the exchange flow path 411 and may have a larger width than that of the exchange flow path 411. Furthermore, a magnet capable of applying magnetic force to a magnetic material may be disposed below the exchange flow path 411, and an analyte combined with a magnetic material in the exchange flow path 411 may be fixed to the exchange flow path 411 by the magnetic force generated from the magnet. Therefore, it is possible to provide diversity for the composition of samples to be injected. Moreover, the expansion passage 411b may be designed to have a volume sufficient to accommodate a solution in the flow chamber 410 and prevent the solution from leaking to the outside. For example, when the volume of analytes and solutions flowing is in excess of a tolerance range (critical capacity), the expansion passage 411b may accommodate the analytes and the solutions exceeding the tolerance range to prevent them from leaking out of the flow chamber adjusting portion 400. Therefore, solutions flowing in the flow chamber 410 may not be leaked to the outside of the flow chamber adjusting portion 400 while passing through the expansion passage 411b. Meanwhile, it is possible to prevent the solutions flowing in the flow chamber 410 from leaking out of the body portion 200 by the expansion passage 411b. Furthermore, in addition to the expansion passage 411b or separately from the expansion passage 411b, it is also possible that a pad made of fibers such as cotton is disposed in the flow chamber 410 to prevent the solutions from leaking to the outside. For example, when the volume of analytes and solutions flowing is in excess of the tolerance range (critical capacity) of the exchange flow path 411 and the flow chamber 410, the pad may absorb the excess amount of the analytes and the solutions to prevent them from leaking out.

Hereinafter, a magnetic separation process of separating analytes from solutions through the exchange flow path 411 will be described. First, when a cylinder is depressurized, solutions and analytes accommodated in the first compartment 211 may flow into the exchange flow path 411 through the exchange hole 260. Thereafter, when a magnetic field is applied from the outside, the analytes bound to magnetic materials may be fixed into the exchange flow path 411 and separated from the flowing solutions. The solutions from which the analytes have been separated may return to the first compartment 211 or flow into the flow chamber 410.

In addition, when a user stops applying a magnetic field after moving the piston 300 to allow the exchange hole 260 and the second compartment 212 to communicate with each other and decompressing a cylinder while an analyte combined with magnetic particles remains in the exchange flow path 411, the analyte may be suspended back in a solution in the second compartment 212.

On the other hand, when the piston 300 is moved while some of a solution in the first compartment 211 remains in the exchange flow path 411, some or all of a solution in the second compartment 212 and the solution in the first compartment 211 may be mixed.

The inspection chamber 412 may serve as a space where tests are performed by reacting purified analytes with enzymes. The inspection chamber 412 may receive the purified analytes through the supply passage 413. In addition, the inspection chamber 412 may be provided with the enzymes capable of reacting with the purified analytes. The enzymes may be provided in advance before the analytes are supplied to the inspection chamber 412. Meanwhile, one side of the inspection chamber 412 may be connected to the supply passage 413, and the other side may be connected to a discharge passage. For example, when analyte and solutions are supplied to the inspection chamber 412 through the supply passage 413, gas in the inspection chamber 412 may be discharged through the discharge passage.

The supply passage 413 may serve as a passage through which analytes and solutions can flow from the outlet 250 of the body portion 200 to the inspection chamber 412. At one side of the supply passage 413, an inlet 413a through which the solutions and the analytes flow from the outlet 250 may be formed. Accordingly, one side of the supply passage 413 may communicate with the outlet 250 through the inlet 413a, and the other side of the supply passage 413 may be connected to the inspection chamber 412. For example, when the piston 300 is inserted into the insertion space 221, blowback occurs in the third compartment 213. As a result of this blowback, the analytes and the solutions may flow from the third compartment 213 to the supply passage 413 through the outlet 250.

The discharge part 414 may be provided to discharge air remaining in the flow chamber 410 to the outside while solutions and analytes accommodated in the main space 210 flow to the exchange flow path 411. For example, when the cylinder is depressurized after a cylinder (not shown) interlocking with the discharge part 414 passes through a film attached to the bottom of the flow chamber adjusting portion 400 and communicates with the flow chamber 410 in the flow chamber adjusting portion 400, air in the flow chamber 410 is discharged to the cylinder and solutions in the main space 210 may be flowed into the flow chamber 410. For another example, when the cylinder is pressurized, it is possible to allow solutions in the flow chamber 410 to flow into the main space 210.

Hereinafter, the operation and effect of the analyte inspection apparatus 1 having the above-mentioned features will be described.

A user may use the analyte inspection apparatus 1 to perform various inspections on samples taken from living organisms or the environment. First, a sample may be taken from living organisms or the environment and mixed with a solution containing a magnetic material. In this case, a biological material contained in the sample is dissolved when the sample is put into the solution, so that at least some of analytes in the biological material may be combined with the magnetic material. As such, the solution containing the analytes combined with the magnetic material may be injected into the first compartment 211 of the main space 210 through the inlet 230. Thereafter, the piston 300 moves so that the first compartment 211 may be located to communicate with the opening 270 and the exchange hole 260.

When the first compartment 211 communicates with the exchange hole 260, it is possible to allow, by depressurization of a cylinder, solutions and analytes to flow between the first compartment 211 and the flow chamber 410. Here, it is possible to fix the analytes bound to a magnetic material to the exchange flow path 411 by applying a magnetic field from the outside. In addition, it is possible to enable the solutions from which the analytes have been separated to flow into the first compartment 211 or the flow chamber 410.

Then, the piston 300 may move to the outside of the body portion 200 so that the second compartment 212 communicates with the exchange hole 260. In this case, the second compartment 212 may be pre-filled with a solution for cleaning an analyte.

When the second compartment 212 communicates with the exchange hole 260, it is possible to make a cleaning solution accommodated in the second compartment 212 flow into the flow chamber 410 by depressurization of a cylinder to clean an analyte coupled to a magnetic material. Here, it is possible to fix the cleaned analyte to the exchange flow path 411 by applying a magnetic field from the outside. Thereafter, when the magnetic field is released, it is possible to make the cleaning solution containing the analyte flow into the second compartment 212 or the flow chamber 410.

In addition, the piston 300 may move to the outside of the body portion 200 so that the third compartment 213 communicates with the exchange hole 260. In this case, the third compartment 213 may be already filled with an elution solution for eluting an analyte from a magnetic material.

When the third compartment 213 communicates with the exchange hole 260, it is possible to make the elution solution accommodated in the third compartment 213 flow into the flow chamber 410 by depressurization of the cylinder to elute the analyte from the magnetic material. In this case, it is possible to fix the magnetic material, which has done its part, by applying a magnetic field from the outside and to make the elution solution containing the analyte flow into the third compartment 213 or the flow chamber 410.

Thereafter, the piston 300 may move into the inside of the body portion 200 so that blowback allows analytes and solutions to be supplied to the inspection chamber 412 sequentially through the outlet 250 and the supply passage 413.

The analyte inspection apparatus 1 according to the embodiment of the present disclosure has effects of easily purifying an analyte of a predetermined sample and uniformly injecting the purified analyte into a plurality of inspection chambers 412.

In addition, since the analyte of the sample can be purified and used for inspection at the same time, it is possible to obtain effects of minimizing the size of the apparatus and reducing the time required for the inspection.

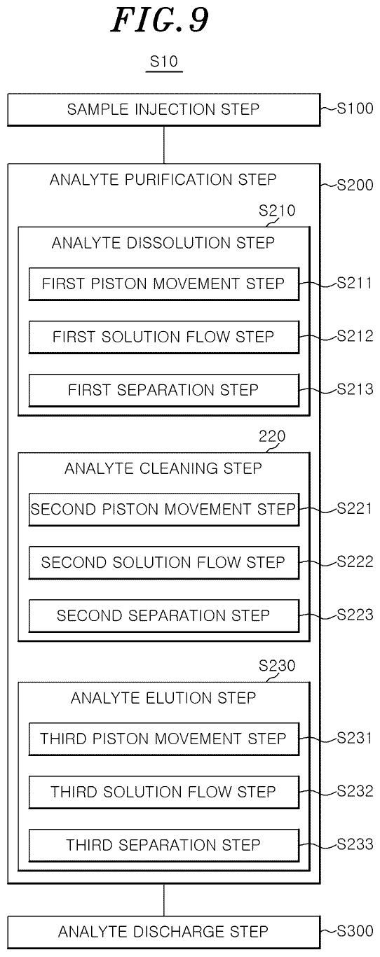

Hereinafter, referring to FIG. 9, an analyte inspection method S10 of inspecting an analyte using the analyte inspection apparatus 1 according to the embodiment of the present disclosure will be described.

The analyte inspection method S10 is a method of performing a predetermined inspection on an analyte contained in a sample by purifying the sample taken from a living body or the environment using the analyte inspection apparatus 1. The analyte inspection method S10 may involve a sample injection step S100, an analyte purification step S200, and an analyte discharge step S300.

In the sample injection step S100, a solution containing a sample taken from a living body or the environment and a magnetic material may be injected into the main space 210 through the inlet 230. In the sample injection step S100, the piston 300 is moved so that the first compartment 211 communicates with the inlet 230 before a sample and a solution are injected. When the position of the piston 300 is adjusted, a solution and a sample or a solution containing the sample may be injected into the first compartment 211. In the sample injection step S100, solutions introduced with samples may include at least one of a lysis/binding buffer and magnetic nano/micro particles, and, more specifically, may include some or all of salts (e.g., Tris-HCl), chelating agents (e.g., ethylenediaminetetraacetic acid (EDTA)), surfactant/detergents (e.g., sodium dodecyl sulfate (SDS) and Triton X-100), reductants (e.g., dithiothreitol (DTT)), chaotropic agents (e.g., guanidine thiocyanate), enzymes (e.g., Proteinase K), and distilled water.

In the case of the analyte inspection apparatus 1 pre-filled with a lysis/binding buffer and a magnetic material, it is possible to immediately inject a sample taken from a living body or the environment or a solution containing the same without mixing it with a separate solution. In addition, when the analyte inspection apparatus 1 is not filled with the lysis/binding buffer and the magnetic material in advance, it is also possible to inject the lysis/binding buffer and the magnetic material together with the sample taken from a living body or the environment or the solution containing the same.

In the analyte purification step S200, analytes in samples may be purified. The analyte purification step S200 may involve an analyte dissolution step S210, an analyte cleaning step S220, and an analyte elution step S230.

In the analyte dissolution step S210, a sample may be dissolved to extract an analyte and bind it to a magnetic material. For example, in the analyte dissolution step S210, the analyte may be extracted by mixing a dissolution solution and the sample injected into the main space 210. The extracted analyte and the magnetic material may be bonded to each other by bringing the analyte and the magnetic material contained in the dissolution solution into contact. Furthermore, the extracted analyte may be bound to an internal control by being brought into contact with the internal control while flowing by a cylinder. The analyte dissolution step S210 may involve a first piston movement step S211, a first solution flow step S212, and a first separation step S213.

In the first piston movement step S211, the piston 300 may be moved so that the first compartment 211 communicates with the exchange hole 260.

In the first solution flow step S212, a cylinder may be driven so that a solution in the first compartment 211 flows into the exchange flow path 411.

In the first separation step S213, a magnetic field may be applied to separate an analyte bound to a magnetic material from a solution. In this case, only the analyte bound to the magnetic material may remain in the exchange flow path 411.

In the analyte cleaning step S220, an analyte bound to a magnetic material may be cleaned. The analyte cleaning step S220 may include a second piston movement step S221, a second solution flow step S222, and a second separation step S223.

In the second piston movement step S221, the piston 300 may be moved so that the second compartment 212 communicates with the exchange hole 260.

In the second solution flow step S222, a cylinder may be driven so that a solution in the second compartment 212 flows into the exchange flow path 411. In addition, a cleaning solution in the second compartment 212 may flow into the exchange flow path 411 and may then be mixed with an analyte remaining in the exchange flow path 411. The mixture of the cleaning solution and the analyte may flow through the second compartment 212 and the exchange flow path as the cylinder is driven, and the analyte may be cleaned by the suspension process. Here, the cleaning solution in the second compartment 212 may include a washing buffer, and, more specifically, may include some or all of diethyl pyrocarbonate (DEPC), sodium citrate tribasic dehydrate, alcohols (e.g., ethanol and 2-propanol), and distilled water.

In the second separation step S223, a magnetic field may be applied to separate an analyte bound to a magnetic material from a cleaning solution. In addition, the cleaning solution separated from the analyte may flow back to the second compartment 212. In this case, only the analyte bound to the magnetic material may remain in the exchange flow path 411.

In the analyte elution step S230, a cleaned analyte may be eluted from a magnetic material. The analyte elution step S230 may include a third piston movement step S231, a third solution flow step S232, and a third separation step S233.

In the third piston movement step S231, the piston 300 may be moved so that the third compartment 213 communicates with the exchange hole 260.

In the third solution flow step S232, a cylinder may be driven so that a solution in the third compartment 213 flows into the exchange flow path 411. In addition, an elution solution in the third compartment 213 may flow into the exchange flow path 411 and may then be mixed with an analyte remaining in the exchange flow path 411. The mixture of the elution solution and the analyte may flow through the third compartment 213 and the exchange flow path 411 as the cylinder is driven, and the analyte may be eluted from a magnetic material by the suspension process. Here, the elution solution in the third compartment 213 may include an elution buffer, and, more specifically, may include some or all of salts (e.g., Tris-HCl), chelating agents (e.g., ethylenediaminetetraacetic acid (EDTA)), diethyl pyrocarbonate (DEPC), and distilled water.

In the third separation step S233, a magnetic material, which has done its part, may be separated from an elution solution containing an eluted analyte by applying a magnetic field. In addition, the elution solution containing the analyte may flow back to the third compartment 213. In this case, only the magnetic material may remain in the exchange flow path 411.

In the analyte discharge step S300, a purified analyte may be pushed out to be supplied to the inspection chamber 412. In the analyte discharge step S300, the piston 300 may be inserted into the body portion 200 to blow back gas in the fourth compartment 214, thereby discharging solutions and analytes in the third compartment 213 through the outlet 250. In this case, the solutions and analytes discharged through the outlet 250 may flow into the inspection chamber 412 through the supply passage 413.

Although the embodiments of the present disclosure have been described as specific embodiments, these are merely examples. The present disclosure is not limited to the above, and should be interpreted as having the widest scope according to the technical idea disclosed in the present specification. Those skilled in the art may combine/substitute the disclosed embodiments to implement a pattern of a shape not disclosed, but this also does not depart from the scope of the present disclosure. In addition, those skilled in the art may easily change or modify the disclosed embodiments based on the present specification, and it is clear that such changes or modifications also fall within the scope of the present disclosure.

What is claimed is:

1. An analyte inspection apparatus comprising:
a body portion having one side open and a main space in which a sample is accommodated;
a piston including one or more partition walls partitioning the main space and the piston being inserted into the main space of the body portion to be movable back and forth; and
an exchange flow path configured to provide a passage for the sample to flow,
wherein the exchange flow path is configured to communicate with any one of the plurality of compartments separated by the one or more partition walls depending on a position of the piston.

2. The analyte inspection apparatus of claim 1, wherein at least one of the plurality of compartments is provided to be filled with a solution for purifying an analyte in the sample.

3. The analyte inspection apparatus of claim 1, wherein the exchange flow path is formed to have one side communicating with the main space, and
wherein the sample accommodated in the main space is configured to flow from the main space to the exchange flow path by a pressure difference applied to a discharge part, the discharge part being configured to communicate with an outside.

4. The analyte inspection apparatus of claim 1, wherein the body portion includes an exchange hole through which the analyte flows into the exchange flow path and an opening through which the main space is exposed to an outside, and
wherein the exchange hole and the opening are formed at positions to communicate with each other through the main space partitioned by the partition wall.

5. The analyte inspection apparatus of claim 1, wherein the body portion includes a protruding part protruding from an end opposite to an end into which the piston is inserted, and
wherein an insertion space is formed in the protruding part to insert at least a portion of the piston.

6. The analyte inspection apparatus of claim 5, wherein the body portion includes a blowback part which is provided at a position spaced apart from the protruding part by a predetermined distance and through which the main space communicates with an outside of the body portion.

7. The analyte inspection apparatus of claim 6, wherein the blowback part includes:
a blowback inlet configured to serve as a passage through which fluid in the main space is discharged;
a blowback outlet configured to serve as a passage through which fluid flows into the main space; and
a bridge which extends in a direction in which the piston moves and through which the blowback inlet and the blowback outlet communicate with each other.

8. The analyte inspection apparatus of claim 6, wherein the body portion includes an outlet through which the analyte is discharged from the body portion after reacting with the solution in the main space and having undergone a predetermined treatment process, and
wherein the outlet is formed at a position spaced apart from the protruding part by a predetermined distance and opposite to the blowback part.

9. The analyte inspection apparatus of claim 8, wherein the piston is configured to move into the insertion space to block between the insertion space and the main space and the gas in the main space is configured to be blown back to push the analyte accommodated in the main space to the outlet.

10. The analyte inspection apparatus of claim 5, wherein the piston further includes a central pillar and a piston head protruding from one end of the central pillar, and
wherein the piston head is selectively inserted into the insertion space according to a movement of the central pillar.

11. The analyte inspection apparatus of claim 10, wherein the one or more partition walls includes a plurality of partition walls, and
wherein the plurality of partition walls extend radially from a circumferential surface of the central pillar and are spaced apart from each other in a direction in which the central pillar moves.

12. The analyte inspection apparatus of claim 10, wherein the piston further includes:
a head sealing member configured to block between the insertion space and the main space by sealing a space between an inner circumferential surface of the protruding part and the piston head when the piston head is inserted into the insertion space; and
a partition wall sealing member provided on an outer circumferential surface of the partition wall to prevent leakage of the solution between the partition wall and the body portion.

13. The analyte inspection apparatus of claim 12, wherein the body portion includes a blowback part which is provided at a position spaced apart from the protruding part by a predetermined distance and through which the main space communicates with an outside of the body portion,
wherein the piston head has a head groove recessed from an outer circumferential surface of the piston head,
wherein the head sealing member is interposed in the head groove, and
wherein the head groove is formed at a position spaced apart from one end of the piston head by a predetermined distance so that the insertion space, the main space, and the blowback part communicate with each other even when at least a portion of the piston head is inserted into the insertion space.

14. The analyte inspection apparatus of claim 2, wherein one of the one or more partition walls is disposed between the compartments adjacent to each other among the plurality of compartments, and
wherein in each of the plurality of compartments, a predetermined solution is filled or the sample is injected, and each of the plurality of compartments performs a predetermined function based on the predetermined solution or the sample.

15. An analyte inspection method using an analyte inspection apparatus including a body portion in which a main space is formed, the method comprising:
injecting a sample or a solution containing the sample into the main space;
purifying an analyte included in the sample injected into the main space; and
discharging the purified analyte from the main space to be supplied to an inspection chamber,
wherein the analyte inspection apparatus includes:
a piston including one or more partition walls partitioning the main space; and
an exchange flow path providing a passage through which the sample flows,
wherein the exchange flow path communicates with any one of the plurality of compartments, which is separated by the one or more partition walls, depending on a position of the piston.

16. The analyte inspection method of claim 15, wherein the purifying includes:
dissolving the sample injected into the main space with a dissolution solution to extract an analyte such that the analyte is bound to at least one of a magnetic material and an internal control material;
cleaning the analyte with a cleaning solution; and
eluting the cleaned analyte from the magnetic material with an elution solution.

17. The analyte inspection method of claim 15, wherein the body portion has a blowback part through which the main space communicates with an outside of the body portion, and
wherein gas in the main space is blown back through the blowback part so that the purified analyte is discharged.

18. The analyte inspection method of claim 15, wherein the sample or the solution containing the sample includes: at least one of a sample of a living body or an environmentally derived sample and a solution containing the living body sample or the environmentally derived sample when the main space is filled with a solution for purifying an analyte in the sample, and
wherein the sample or the solution containing the sample includes at least one of the living body sample or the environmentally derived sample and the solution containing the living body sample or the environmentally derived sample and the solution for purifying the analyte in the sample when the main space is not filled with the solution for purifying the analyte in the sample.

19. The analyte inspection method of claim 16, wherein the cleaning solution includes at least one of a washing buffer, alcohol, and distilled water, and
wherein the elution solution includes at least one of an elution buffer, a chelating agent, and distilled water.

20. The analyte inspection method of claim 16, wherein the dissolving includes separating an analyte from the solution by fixing the analyte to the exchange flow path using magnetic force while one of the plurality of compartments communicates with the exchange flow path,
wherein the cleaning includes separating the analyte from the cleaning solution by fixing the analyte to the exchange flow path while another one of the plurality of compartments communicates with the exchange flow path, and
wherein the eluting includes separating the analyte using the elution solution filled in still another one of the plurality of compartments before discharging the analyte.
